(19) United States
(12) Patent Application Publication
(10) Pub. No.: US 2014/0070908 A1
(43) Pub. Date: Mar. 13, 2014

(54) STATIONARY CONTACT ARM ASSEMBLY FOR MOLDED CASE CIRCUIT BREAKER

(71) Applicant: LSIS CO., LTD., Anyang-si (KR)

(72) Inventor: Jun Yong JANG, Cheongju-si (KR)

(73) Assignee: LSIS CO., LTD., Anyang-si (KR)

(21) Appl. No.: 14/017,912

(22) Filed: Sep. 4, 2013

(30) Foreign Application Priority Data
Sep. 11, 2012 (KR) 10-2012-0100610

(51) Int. Cl. H01H 3/00

(52) U.S. Cl. CPC H01H 3/00
USPC 335/16

(57) ABSTRACT

A stationary contact arm assembly for a molded case circuit breaker includes a stationary contact arm having a terminal portion and a contact portion provided at both end portions thereof in the length direction, and an inclined extension portion provided between the contact portion and the terminal portion, a flat extension portion forming a space between the flat extension portion and a bottom surface of the contact potion, a bent portion formed from the flat extension portion to the terminal portion; a magnet assembly having a plurality of steel plates at least part of which is installed to be pushed into a space between the flat extension portion and contact portion in the stationary contact arm; and an elastic support plate having an elastic support portion installed on the flat extension portion of the stationary contact arm to support the magnet assembly.

### CROSS-REFERENCE TO RELATED APPLICATIONS

Pursuant to 35 U.S.C. §119(a), this application claims the benefit of earlier date and right of priority to Korean Patent Application No. 10-2012-0100610, filed on Sep. 11, 2012, the contents of which is incorporated by reference herein in its entirety.

### BACKGROUND OF THE INVENTION

1. Field of the Invention

The present disclosure relates to a molded case circuit breaker, and more particularly, to a stationary contact arm assembly for a molded case circuit breaker.

2. Description of the related art

A molded case circuit breaker is a power device having a protective function to switch a relatively low voltage power circuit under several hundred volts or trip a circuit when a fault current such as an over current or short-circuit current occurs on the circuit.

As is well known, a molded case circuit breaker may include a stationary contact arm, a movable contact arm having a closed position formed to be brought into contact with the stationary contact arm and an open position formed to be separated from the stationary contact arm so as to break an electrical circuit, a switching mechanism configured to provide a driving force for driving the movable contact arm to a closed or open position, a trip mechanism configured to sense a fault current when it occurs on the circuit so as to trigger the operation of the switching mechanism to the open position, an extinguishing mechanism installed around the movable contact arm and stationary contact arm to extinguish an arc occurring during the open position operation, an enclosure for accommodating the constituent elements, namely, an upper cover and a lower case, and the like.

The molded case circuit breaker may also include a molded case circuit breaker with a current limiting function for automatically limiting a fault current using an electromagnetic repulsive force generated between the contacts of the stationary contact arm and movable contact arm when the fault current occurs, and a molded case circuit breaker without the current liming function.

In order to perform such a current limiting function, the stationary contact arm should be a current limiting type stationary contact arm, and the current is limiting type stationary contact arm with a terminal portion and a contact portion formed at both ends thereof has a laid down U-shaped geometric feature in which the contact portion is bent toward the side of the terminal portion.

Owing to the geometric feature, the direction of a current flowing into the contact portion and direction of a current flowing out of the contact portion are opposite to each other, and thus a magnetic field formed around the flowing-in current and flowing-out current are repulsive to each other, and in particular when a current flowing through the circuit is abnormally large, the corresponding magnetic repulsive force becomes large to the extent that the movable contact arm is pushed out in the direction of being separated from the stationary contact arm.

The present disclosure relates to the current limiting type stationary contact arm assembly in which the movable contact arm is separated from the stationary contact arm using a magnetic repulsive force, thereby automatically limiting an abnormal current on an electric circuit. For such a current limiting type stationary contact arm assembly, there has been disclosed a technology in which a magnet assembly formed with a plurality of steel plates is attached to the stationary contact arm to more greatly generate an electromagnetic repulsive force for the current limiting function, thereby enhancing the magnetic permeability of the stationary contact arm. However, during the switching operation between the movable contact arm and stationary contact arm of the molded case circuit breaker or subsequent to the current limiting operation, it is required to maintain the position of the magnet assembly formed with a plurality of steel plates in a stationary manner even with repeated shocks while the movable contact arm is returned again to a is position in contact with the stationary contact arm.

In positionally fixing the magnet assembly to the stationary contact arm, a method of fastening the magnet assembly with the stationary contact arm using a retaining screw has been used in the related art.

However, the related art in which the magnetic assembly and the stationary contact arm are fastened with a retaining screw further requires a retaining screw and accompanies the process of fastening the corresponding retaining screw, thereby causing a problem of increasing the cost of the molded case circuit breaker and reducing the productivity.

### SUMMARY OF THE INVENTION

Accordingly, the present disclosure is contrived to solve the foregoing problem of the related art, and an object of the present disclosure is to provide a stationary contact arm assembly for a molded case circuit breaker in which the process of fastening a retaining screw is not required to fix the magnet assembly to the stationary contact arm.

The object of the present disclosure may be accomplished by providing a stationary contact arm assembly for a molded case circuit breaker, comprising:

a current limiting type stationary contact arm having a terminal portion and a contact portion provided at both end portions thereof in the length direction, and an inclined extension portion provided between the contact portion and the terminal portion and formed to be downwardly extended in an inclined manner from the terminal portion, a flat extension portion forming a space between the flat extension portion and a bottom surface of the contact potion, a bent portion is formed in a bent shape from the flat extension portion to the terminal portion;

a magnet assembly having a plurality of steel plates at least part of which is installed to be pushed into the space between the flat extension portion and contact portion in the stationary contact arm to enhance the magnetic permeability so as to increase an electromagnetic repulsive force during the current limiting operation; and

an elastic support plate having an elastic support portion installed on the flat extension portion of the stationary contact arm to support the magnet assembly.

According to an aspect of the present disclosure, the flat extension portion of the stationary contact arm may be provided with a concave groove portion into which the elastic support portion is inserted.

According to another aspect of the present disclosure, the elastic support portion may include a plurality of long perforated hole portions; and a plurality of body portions formed between the perforated hole portions.

According to still another aspect of the present disclosure, the concave groove portion may be configured with a groove portion formed with a pair of first inclined surfaces formed in an inclined manner to be deep toward a central portion in the length direction and a first flat surface between the pair of first inclined surfaces, and the plurality of body portions may have a pair of second inclined surfaces formed in an inclined manner to be downwardly convex toward a central portion in the length direction in correspondence to the concave groove portions, respectively, and a second flat surface between the pair of second inclined surfaces.

According to yet still another aspect of the present disclosure, the flat is extension portion of the stationary contact arm may be provided with a concave groove portion into which the elastic support portion is inserted, and the elastic support portion may include a plurality of long perforated hole portions; and a plurality of body portions formed between the perforated hole portions, wherein the plurality of body portions are formed in an inclined manner to be downwardly convex toward a central portion in the length direction, and the downwardly convex height of the body portion is greater than the groove depth of the concave groove portion.

According to still yet another aspect of the present disclosure, the stationary contact arm may include a pair of retaining screw opening portions provided to be protruded in the horizontal direction from both lateral surfaces of the flat extension portion, respectively, to allow the penetration of a retaining screw for fixing it to the molded case circuit breaker, and the elastic support plate may include a screw through opening portion for allowing the penetration of the retaining screw.

According to yet still another aspect of the present disclosure, the screw through opening portion may be configured with a long hole portion.

According to yet still another aspect of the present disclosure, the elastic support portion further comprises a pair of magnet release prevention wall portions formed to be extended as much as a predetermined height enough to prevent the transverse directional release of the magnet assembly in the vertically upward direction from both the width directional end portions of the flat elastic support plate.

According to yet still another aspect of the present disclosure, a distance between the pair of the magnet release prevention wall portions is formed to be less than by a predetermined distance or equal to the width of the magnet assembly.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view illustrating the configuration of a stationary contact arm in a stationary contact arm assembly for a molded case circuit breaker according to a preferred embodiment of the present disclosure;

FIG. 2 is a perspective view illustrating the configuration of an elastic support plate in a stationary contact arm assembly for a molded case circuit breaker according to a preferred embodiment of the present disclosure; and

FIG. 3 is a perspective view illustrating a configuration in which a stationary contact arm assembly for a molded case circuit breaker according to a preferred embodiment of the present disclosure is assembled.

### DETAILED DESCRIPTION OF THE INVENTION

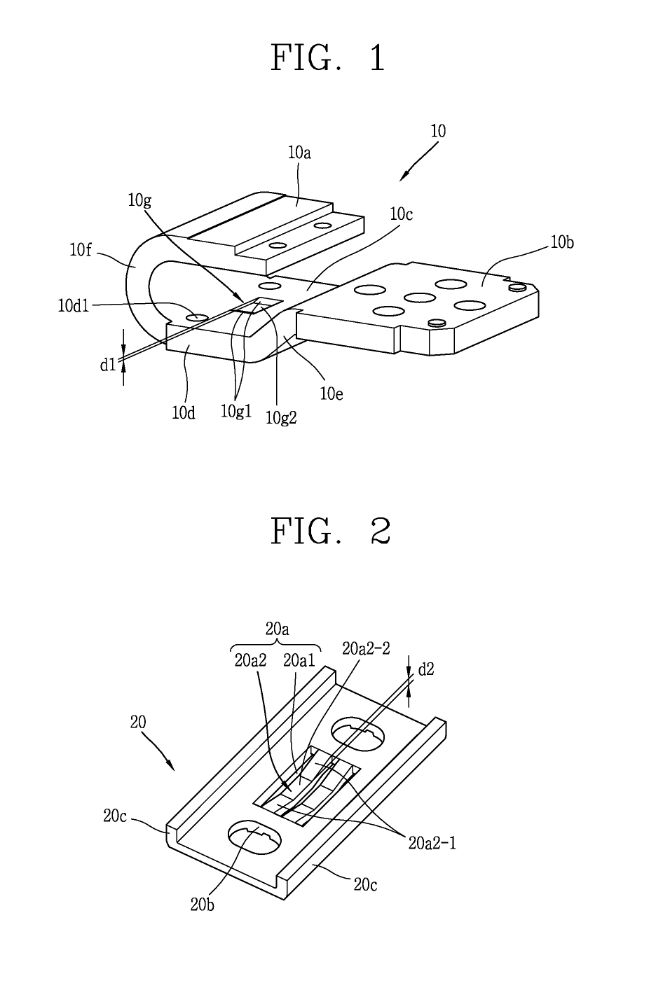

The objective of the present invention, as well as the configuration and working effect thereof to accomplish the foregoing objective will be more clearly understood by the following description for the preferred embodiments of present is disclosure with reference to the accompanying drawings such as FIGS. 1 through 3.

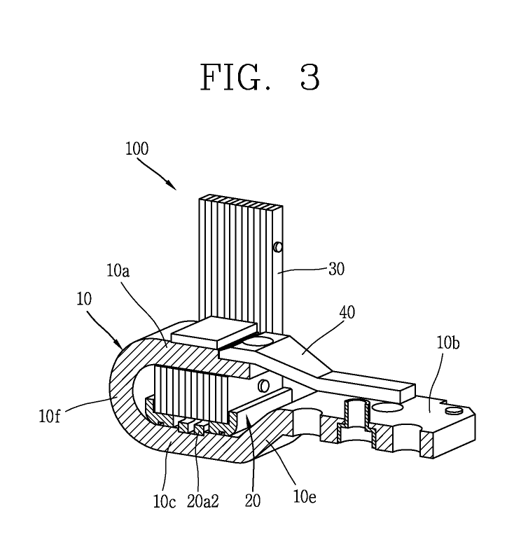

Referring to FIG. 3, a stationary contact arm assembly 100 for a molded case circuit breaker according to a preferred embodiment of the present disclosure may include a current limiting type stationary contact arm 10, a magnet assembly 30, and an elastic support plate 20.

First, the detailed configuration of the current limiting type stationary contact arm 10 will be described with reference to FIG. 1.

The current limiting type stationary contact arm 10 has a terminal portion 10b and a contact portion 10a provided at both end portions thereof in the length direction, and has a laid down U-shaped geometric feature in which the contact portion 10a is bent toward the side of the terminal portion 10b.

The current limiting type stationary contact arm 10 may further include an inclined extension portion 10e, a flat extension portion 10c, and a bent portion 10f.

The inclined extension portion 10e is provided between the contact portion 10a and the terminal portion 10b and formed to be downwardly extended in an inclined manner from the terminal portion 10b.

The flat extension portion 10c is a portion forming a space in which the magnet assembly 30 and elastic support plate 20 can be installed between the same and a bottom surface of the contact potion 10a.

The bent portion 10f is a portion of the current limiting type stationary contact arm 10 formed in a bent shape from the flat extension portion 10c to the terminal portion 10b.

Referring to FIG. 3, the stationary contact arm assembly 100 for a molded case circuit breaker according to a preferred embodiment of the present disclosure is may be provided in an extended manner from an end portion of the contact portion 10a, and may further include an arc runner 40 for inducing an arc.

On the other hand, referring to FIG. 3, the magnet assembly 30 is a means for enhancing the magnetic permeability to increase an electromagnetic repulsive force between the current limiting type stationary contact arm 10 and the movable contact arm (not shown) during the current limiting operation. As illustrated in the drawing, the magnet assembly 30 may be configured in such a manner that a plurality of steel plates are laminated and fastened by a fastening means such as a rivet. Here, the steel plate may be configured with an L-shaped steel plate, for instance.

The magnet assembly 30 is installed in such a manner that at least part of each steel plate is pushed into the space between the flat extension portion 10c and contact portion 10a of the current limiting type stationary contact arm 10.

The elastic support plate 20 is installed in a stationary manner on the flat extension portion 10c of the current limiting type stationary contact arm 10 as illustrated in FIG. 3, and the elastic support plate 20 has an elastic support portion 20a for supporting the magnet assembly 30 as illustrated in FIG. 3 or 2.

According to a preferred embodiment, the elastic support plate 20 may be formed of a synthetic resin plate, which is so-called plastic, having elasticity, and according to another embodiment, the elastic support plate 20 may be formed of a metal plate such as a thin steel plate having elasticity.

The flat extension portion 10c of the current limiting type stationary contact arm 10 may include a concave groove portion 10g into which the elastic support portion 20a is inserted as illustrated in FIG. 1, in correspondence to the elastic support portion 20a.

The concave groove portion 10g is configured with a groove portion, which is formed with a pair of first inclined surfaces 10g1, and a first flat surface 10g2.

The pair of first inclined surfaces 10g1 is formed in an inclined manner to be deep toward a central portion in the length direction of the concave groove portion 10g.

The first flat surface 10g2 is formed with a plane as the most bottom portion in the concave groove portion 10g, which is formed between a pair of first inclined surfaces.

As illustrated in FIG. 2, the elastic support portion 20a may include a plurality of long perforated hole portions 20a1, and a plurality of body portions 20a2 formed between a pair of perforated hole portions 20a1 adjacent to each other.

The plurality of body portions 20a2 have a pair of second inclined surfaces 20a2-1 formed in an inclined manner to be downwardly convex toward a central portion in the length direction in correspondence to the concave groove portions 10g of the stationary contact arm 10, respectively, and a second flat surface 20a2-2 formed between the pair of second inclined surfaces 20a2-1 to form the most bottom surface in the body portion 20a2.

The plurality of body portions 20a2 are formed in an inclined manner to be downwardly convex toward a central portion in the length direction, and the downwardly convex height (refer to reference character d2 in FIG. 2) of the body portion 20a2 is greater (higher) than the groove depth (refer to reference character d1 in FIG. 1) of the concave groove portion 10g.

It is expressed as the following Equation (1).

d2>d1 (1)

In Equation (1), reference character d1 represents the groove depth of the concave groove portion 10g, and reference character d2 represents the downwardly convex height (i.e., downwardly protrusion height) of the body portion 20a2.

Furthermore, as illustrated in FIG. 1, the stationary contact arm 10 may include a pair of retaining screw opening portions 10d provided to be protruded in the horizontal direction from both lateral surfaces of the flat extension portion 10c, respectively, to allow the penetration of a retaining screw (not shown) for fixing the stationary contact arm 10 to the molded case circuit breaker, and each of the retaining screw opening portions 10d is provided with a retaining screw opening 10d1.

The elastic support plate 20 may include a screw through opening portion 20b for allowing the penetration of the retaining screw, and preferably configured with a pair of the screw through opening portions 20b. A distance between the pair of screw through opening portions 20b is predetermined as a distance enough to install a lower portion of the magnet assembly 30 therebetween. In other words, referring to FIG. 3, a distance between the pair of screw through opening portions 20b to a forward/backward directional width of the magnet assembly 30 is formed in a sufficiently long manner as much as the predetermined length.

According to a preferred aspect of the present disclosure, the screw through opening portion 20b is configured with a long hole portion.

Furthermore, the elastic support plate 20 has a pair of magnet release prevention wall portions 20c as illustrated in FIG. 2, and the pair of magnet release prevention wall portion 20c are a portion formed to be extended as much as a predetermined height enough to prevent the transverse directional release of the magnet assembly 30 in the vertically upward direction from both the width directional end portions of the flat elastic support plate 20.

A distance between the pair of the magnet release prevention wall portions 20c is formed to be less than by a predetermined distance or equal to the width of the magnet assembly 30 as illustrated in FIG. 3, and thus when the magnet assembly 30 is pushed between the pair of the magnet release prevention wall portions 20c, the pair of the magnet release prevention wall portions 20c becomes open wider to elastically press both the lateral surfaces of the magnet assembly 30, thereby maintaining a coupling state between the magnet assembly 30 and the elastic support plate 20.

Owing the provision of the magnet release prevention wall portion 20c, the longitudinal cross-sectional area of the elastic support plate 20 has a U-shape.

Next, the assembly method and working effect of a stationary contact arm assembly for a molded case circuit breaker according to a preferred embodiment of the present disclosure will be described below.

First, the assembly method of a stationary contact arm assembly for a molded case circuit breaker according to a preferred embodiment of the present disclosure will be described below.

A contact to which reference numeral is not given is attached to the contact portion 10a of the stationary contact arm 10 by welding as illustrated in FIG. 1.

Next, the magnet assembly 30 is installed to be pushed into between the magnet release prevention wall portions 20c of the elastic support plate 20, and a lower portion of the magnet assembly 30 is positioned between a pair of screw through opening portions 20b not to obstruct the pair of screw through opening portions 20b.

At this time, a distance between the pair of the magnet release prevention wall portions 20c is formed to be less than by a predetermined distance or equal to the width of the magnet assembly 30 as illustrated in FIG. 3, and thus when the magnet assembly 30 is pushed between the pair of the magnet release prevention wall portions 20c, the pair of the magnet release prevention wall portions 20c becomes open wider to elastically press both the lateral surfaces of the magnet assembly 30, an as a result, a coupling state between the magnet assembly 30 and the elastic support plate 20 is maintained.

Next, the process of installing the assembly of the assembled elastic support plate 20 and magnet assembly 30 on the stationary contact arm 10 will be described below.

When the elastic support portion 20a is pushed into the concave groove portion 10g of the stationary contact arm 10, the second flat surface 20a2-2 and second inclined surface 20a2-1 of the elastic support portion 20a moves down along the first inclined surface 10g1 of the concave groove portion 10g and the assembly of the assembled elastic support plate 20 and magnet assembly 30 is positionally fixed to the stationary contact arm 10 while the second flat surface 20a2-2 is mounted on the first flat surface 10g2. At this time, the downwardly convex height (d2) of the body portion 20a2 is greater (higher) than the groove depth (d1) of the concave groove portion 10g, and thus the body portion 20a2 is compressed by a height difference between the downwardly convex height (d2) of the body portion 20a2 and the groove depth (d1) of the concave groove portion 10g, and if the body portion 20a2 is once mounted on the concave groove portion 10g, then the elastic support plate 20 will be fixed by an elastically repulsive force of the body portion 20a2 that is going to be extended to the original downwardly convex height, thereby preventing the elastic support plate 20 from being released from the stationary contact arm 10.

Next, when the arc runner 40 is screw-fastened and fixed to an end portion of the contact portion 10a using a retaining screw, the assembly process of the stationary contact arm assembly as illustrated in FIG. 3 will be completed.

The assembled stationary contact arm assembly may pass through the retaining screw opening 10d1 provided at the retaining screw opening portion 10d using a retaining screw (not shown) to be fixed to an enclosure bottom surface of the molded case circuit breaker (not shown) as illustrated in FIG. 1. Here, the retaining screw may be a retaining screw for fixing the stationary contact arm assembly to the molded case circuit breaker, but not a retaining screw for fixing the magnet assembly to the stationary contact arm.

As described above, a stationary contact arm assembly for a molded case circuit breaker according to the present disclosure may include the elastic support plate 20 having the elastic support portion 20a supporting the magnet assembly 30, and thus a retaining screw for fixing the magnet assembly 30 to the stationary contact arm may be not required to reduce the cost due to the retaining screw, and the process of fastening the retaining screw may be not required to enhance the productivity.

In a stationary contact arm assembly for a molded case circuit breaker according to the present disclosure, the stationary contact arm 10 may be provided with the concave groove portion 10g into which the elastic support portion 20a is inserted, thereby allowing the installation of the elastic support plate 20 to be easily completed by inserting the elastic support portion 20a of the elastic is support plate 20 into the concave groove portion 10g of the stationary contact arm.

In a stationary contact arm assembly for a molded case circuit breaker according to the present disclosure, the elastic support portion 20a may have a configuration in which the elastic support portion 20a includes the plurality of long perforated hole portions 20a1 and a plurality of body portions 20a2 formed between the long perforated hole portions 20a1 and thus the elastic support plate 20 itself supports the magnet assembly 30 by an elastic force, and accordingly, the elastic support plate 20 may support the magnet assembly 30 with its own elastic force with no additional constituent elements such as springs to provide simple constituent components, thereby reducing the production cost as well as facilitating the production process.

In a stationary contact arm assembly for a molded case circuit breaker according to the present disclosure, the concave groove portion 10g may be configured with a groove portion formed with a pair of first inclined surfaces 10g1 formed in an inclined manner to be deep toward a central portion in the length direction and a first flat surface 10g2 between the pair of first inclined surfaces 10g1, and the plurality of body portions 20a2 may have a pair of second inclined surfaces 20a2-1 formed in an inclined manner to be downwardly convex toward a central portion in the length direction in correspondence to the concave groove portions 10g, and a second flat surface 20a2-2 between the pair of second inclined surfaces 20a2-1, thereby allowing the second flat surface 20a2-1 and second inclined surface 20a2-1 to be efficiently guided along the first inclined surface 10g1 while installing the elastic support plate 20 on the stationary contact arm 10 as well as allowing the elastic support plate 20 to be securely fixed to the stationary contact arm 10 when the second flat surface 20a2-2 is mounted on the first flat surface 10g2 to prevent the elastic support plate 20 from being released from the stationary contact arm 10.

In a stationary contact arm assembly for a molded case circuit breaker according to the present disclosure, the downwardly convex height (d2) of the body portion 20a2 may be greater (higher) than the groove depth (d1) of the concave groove portion 10g, and thus the body portion 20a2 may be compressed by a height difference between the downwardly convex height (d2) of the body portion 20a2 and the groove depth (d1) of the concave groove portion 10g, and if the body portion 20a2 is once mounted on the concave groove portion 10g, then the elastic support plate 20 will be fixed by an elastically repulsive force of the body portion 20a2 that is going to be extended to the original downwardly convex height, thereby preventing the elastic support plate 20 from being released from the stationary contact arm 10.

In a stationary contact arm assembly for a molded case circuit breaker according to the present disclosure, the stationary contact arm 10 may include a pair of retaining screw opening portions 10d provided to be protruded in the horizontal direction from both lateral surfaces of the flat extension portion 10c, respectively, to allow the penetration of a retaining screw for fixing it to the molded case circuit breaker, and the elastic support plate 20 may include a screw through opening portion 20b for allowing the penetration of the retaining screw, and thus the retaining screw may be fixed to an enclosure bottom surface of the molded case circuit breaker the retaining screw opening 10d1 of the retaining screw opening portion 10d and the screw through opening portion 20b, thereby obtaining an effect of allowing the stationary contact arm 10 to be positionally fixed thereto in a secure manner.

In a stationary contact arm assembly for a molded case circuit breaker according to the present disclosure, the screw through opening portion 20b may be configured with a long hole portion, thereby allowing the penetration of a retaining screw in a flexible manner within the length of the long hole even when the retaining screw opening portion 10d and screw through opening portion 20b are not formed on a straight line.

What is claimed is:

1. A stationary contact arm assembly for a molded case circuit breaker, comprising:
a current limiting type stationary contact arm having a terminal portion and a contact portion provided at both end portions thereof in the length direction, and an inclined extension portion provided between the contact portion and the terminal portion and formed to be downwardly extended in an inclined manner from the terminal portion, a flat extension portion forming a space between the flat extension portion and a bottom surface of the contact potion, a bent portion formed in a bent shape from the flat extension portion to the terminal portion;
a magnet assembly having a plurality of steel plates at least part of which is installed to be pushed into the space between the flat extension portion and contact portion in the stationary contact arm to enhance the magnetic permeability so as to increase an electromagnetic repulsive force during the current limiting operation; and
an elastic support plate having an elastic support portion installed on the flat extension portion of the stationary contact arm to support the magnet assembly.

2. The stationary contact arm assembly for a molded case circuit breaker of claim 1, wherein the flat extension portion of the stationary contact arm is provided with a concave groove portion into which the elastic support portion is inserted.

3. The stationary contact arm assembly for a molded case circuit breaker of claim 1, wherein the elastic support portion comprises:
a plurality of long perforated hole portions; and
a plurality of body portions formed between the perforated hole portions.

4. The stationary contact arm assembly for a molded case circuit breaker of claim 2, wherein the concave groove portion is configured with a groove portion formed with a pair of first inclined surfaces formed in an inclined manner to be deep toward a central portion in the length direction and a first flat surface between the pair of first inclined surfaces, and
the elastic support portion has a plurality of body portions having a pair of second inclined surfaces formed in an inclined manner to be downwardly convex toward a central portion in the length direction in correspondence to the concave groove portion, respectively, and a second flat surface between the pair of second inclined surfaces.

5. The stationary contact arm assembly for a molded case circuit breaker of claim 1, wherein the flat extension portion of the stationary contact arm is provided with a concave groove portion into which the elastic support portion is inserted, and
the elastic support portion comprises:
a plurality of long perforated hole portions; and
a plurality of body portions formed between the perforated hole portions,
wherein the plurality of body portions are formed in an inclined manner to be downwardly convex toward a central portion in the length direction, and
the downwardly convex height of the body portion is greater than the groove depth of the concave groove portion.

6. The stationary contact arm assembly for a molded case circuit breaker of claim 1, wherein the stationary contact arm comprises a pair of retaining screw opening portions provided to be protruded in the horizontal direction from both lateral surfaces of the flat extension portion, respectively, to allow the penetration of a retaining screw for fixing it to the molded case circuit breaker, and
the elastic support plate comprises a screw through opening portion for allowing the penetration of the retaining screw.

7. The stationary contact arm assembly for a molded case circuit breaker of claim 6, wherein the screw through opening portion is configured with a long hole portion.

8. The stationary contact arm assembly for a molded case circuit breaker of claim 3, wherein the elastic support portion further comprises a pair of magnet release prevention wall portions formed to be extended as much as a predetermined height enough to prevent the transverse directional release of the magnet assembly in the vertically upward direction from both the width directional end portions of the flat elastic support plate.

9. The stationary contact arm assembly for a molded case circuit breaker of claim 8, wherein a distance between the pair of the magnet release prevention wall portions is formed to be less than by a predetermined distance or equal to the width of the magnet assembly.
